(19) United States
(12) Patent Application Publication
(10) Pub. No.: US 2015/0158254 A1
(43) Pub. Date: Jun. 11, 2015

(54) CLEANING DEVICE

(71) Applicants: XYZprinting, Inc., New Taipei City (TW); Cal-Comp Electronics & Communication Company Limited, New Taipei City (TW); Kinpo Electronics, Inc., New Taipei City (TW)

(72) Inventor: Jui-Feng Chang, New Taipei City (TW)

(73) Assignees: XYZprinting, Inc., New Taipei City (TW); Cal-Comp Electronics & Communication Company Limited, New Taipei City (TW); Kinpo Electronics, Inc., New Taipei City (TW)

(21) Appl. No.: 14/156,479

(22) Filed: Jan. 16, 2014

(30) Foreign Application Priority Data
Dec. 11, 2013 (TW) 102223361

(51) Int. Cl. B29C 67/00

(52) U.S. Cl. CPC B29C 67/0096

(57) ABSTRACT

A cleaning device for removing a residue adhered to a discharging nozzle of a three-dimensional printing apparatus is provided. The cleaning device includes a plate and at least one flexible cleaning member disposed on the plate. The flexible cleaning member has a notch corresponding to an outer profile of the discharging nozzle.

### CROSS-REFERENCE TO RELATED APPLICATION

This application claims the priority benefit of Taiwan application serial no. 102223361, filed on Dec. 11, 2013. The entirety of the above-mentioned patent application is hereby incorporated by reference herein and made a part of this specification.

### BACKGROUND OF THE INVENTION

1. Field of the Invention

The invention relates to a cleaning device; more particularly, the invention relates to a cleaning device configured for removing a residue adhered to a discharging nozzle of a three-dimensional (3D) printing apparatus.

2. Description of Related Art

With the advance in computer-aided manufacturing (CAM), the manufacturing industry has developed a rapid prototyping (RP) technology to rapidly convert original design concept into physical objects. The RP technology is not limited to any geometric shape. In addition, the more complex the components are, the more excellent the RP technology is demonstrated. The RP technology may greatly save manpower and processing time. With a demand of shortest time, a three-dimensional (3D) component designed by using CAM may be truthfully presented as touchable. Furthermore, a geometric curve of the 3D component could be truthfully appreciated. Moreover, assembly ability of the component thereof may be tested and even functions thereof may possibly be tested.

At present, one of the RP technologies commonly seen is a fused deposition modeling (FDM). A manufacturing process of the FDM is, for example, to heat filaments, such as regular resin, nylon resin and plastic resin, up to a melting point and then, to spray a melted liquid material to a molding station. The sprayed liquid material will be solidified after being cooled rapidly on a base and be formed layer by layer into a desired shape. However, during a three-dimensional (3D) printing process, a small portion of the filament may adhere to the discharging nozzle and printing quality of subsequent printing tasks may be adversely affected.

### SUMMARY OF THE INVENTION

The disclosure provides a cleaning device for cleaning off a residue adhered to a discharging nozzle of a three-dimensional (3D) printing apparatus.

A cleaning device of the disclosure is configured for removing a residue adhered to a discharging nozzle of a 3D printing apparatus. The cleaning device includes a plate and at least one flexible cleaning member. The flexible cleaning member is disposed on the plate and has a notch corresponding to an outer profile of the discharging nozzle.

In an embodiment of the disclosure, the aforesaid notch includes a first trench extending along a first direction.

In an embodiment of the disclosure, a cross section of the first trench is in a V shape.

In an embodiment of the disclosure, the aforesaid notch further includes a second trench extending along a second direction, and the first direction is perpendicular to the second direction.

In an embodiment of the disclosure, a cross section of the second trench is in a V shape.

In an embodiment of the disclosure, the aforesaid cleaning device is disposed on a base of the 3D printing apparatus, and the base is configured to carry a sprayed object sprayed from the discharging nozzle.

A rotating mechanism is further included in an embodiment of the disclosure, wherein the plate and flexible cleaning members are located on the rotating mechanism.

In an embodiment of the disclosure, the aforesaid rotating mechanism includes a motor.

In an embodiment of the disclosure, a material of the aforesaid plate includes metal or hard plastic.

In an embodiment of the disclosure, a material of the aforesaid flexible cleaning member includes a heat-resisting material.

In view of the above, a melted filament may adhere to the discharging nozzle of the 3D printing apparatus during a 3D printing process, and, after the 3D printing process is completed, a remaining filament may still adhere to a lower portion of the discharging nozzle. Therefore, the cleaning device of the disclosure may be disposed on the base of the 3D printing apparatus. After a 3D printing process is completed, the discharging nozzle may be moved to a location of the cleaning device for the plate of the cleaning device to cut off the remaining filament exposed at the lower portion of the discharging nozzle, and for the flexible cleaning members to scrape off the residue adhered to side surfaces of the discharging nozzle, so as to complete a cleaning task on the discharging nozzle, such that printing quality of subsequent printing tasks will not be adversely affected. Furthermore, in order to ensure complete cleanliness of a peripheral side of the discharging nozzle, the flexible cleaning members may include trenches having perpendicular directions so as to expand a scraping area of the peripheral side of the discharging nozzle. Alternatively, the plate and the flexible cleaning members may be disposed on the rotating mechanism, such that the flexible cleaning members are capable of rotating at 360 degrees and scraping off the residue adhered to the peripheral side of the discharging nozzle.

Several exemplary embodiments accompanied with figures are described in detail below to further describe the disclosure in details.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1A is a partial three-dimensional (3D) view illustrating a cleaning device and a discharging nozzle according to an embodiment of the disclosure.

FIG. 1B is a front view of FIG. 1A.

FIG. 2 is a partial 3D view illustrating a cleaning device according to another embodiment of the disclosure.

FIG. 3 is a partial 3D view illustrating a cleaning device and a discharging nozzle according to yet another embodiment of the disclosure.

### DETAILED DESCRIPTION OF DISCLOSED EMBODIMENTS

A cleaning device of the disclosure is configured for removing a residue adhered to a discharging nozzle of a three-dimensional (3D) printing apparatus. Specifically, during a printing process, the discharging nozzle of the 3D printing apparatus sprays a melted filament. A portion of the filament may be sprayed to a peripheral side of the discharging nozzle, and adhere to the discharging nozzle. Furthermore, after the 3D printing apparatus completes a printing task, one small portion of a remaining filament may still flow to a lower portion of the discharging nozzle under the influence of gravity, such that a small piece of the remaining filament remains on the lower portion of the discharging nozzle. The cleaning device of the disclosure may clean the residue adhered to the lower portion and the peripheral side of the discharging nozzle, so as to prevent the residue adhered to the discharging nozzle from adversely affecting subsequent printing quality. In the following, the cleaning device of the disclosure is elaborated in detail hereinafter.

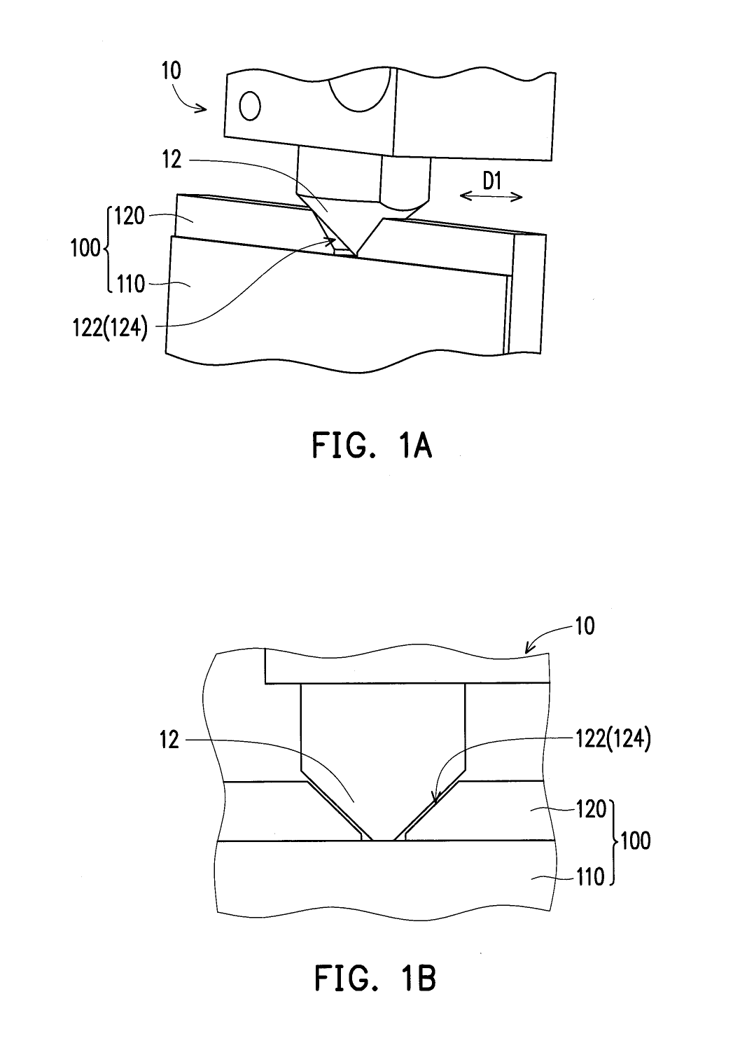

FIG. 1A is a partial three-dimensional (3D) view illustrating a cleaning device and a discharging nozzle according to an embodiment of the disclosure. FIG. 1B is a front view of FIG. 1A. With reference to FIG. 1A and FIG. 1B, a cleaning device 100 includes a plate 110 and at least one flexible cleaning member 120. The flexible cleaning member 120 is disposed on the plate 110, and has a notch 122 corresponding to an outer profile of a discharging nozzle 12. The flexible cleaning member 120 may be a scarping blade or a wiper, but type of the flexible cleaning member 120 is not limited thereto.

Generally speaking, a three-dimensional (3D) printing apparatus 10 has a base (not shown) configured to carry a sprayed object sprayed from the discharging nozzle 12. The cleaning device 100 of the present embodiment may be disposed on the base of the 3D printing apparatus 10. Since the 3D printing apparatus 10 has a positioning sensor (not shown) in three-dimensional (3D) directions (X-Y-Z), the positioning sensor may, first of all, confirm a zero position and drive a belt (not shown) or a lead pole (not shown) by rotating a stepping motor (not shown), and further move the discharging nozzle 12 to a specific location for performing a printing procedure. Thus, if the cleaning device 100 is disposed on the base of the 3D printing apparatus 10, the discharging nozzle 12 may be controlled and moved to a location where the cleaning device 100 is positioned for performing a cleaning procedure. Namely, in the present embodiment, the cleaning device 100 does not move. Rather, the cleaning device 100 scrapes off a residue adhered to the discharging nozzle 12 by moving the discharging nozzle 12.

In the present embodiment, the plate 110 is an iron plate. Since the discharging nozzle 12 is no longer heated after a printing task is completed, the residue hanging over a lower portion of the discharging nozzle 12 may become hard due to dropped temperatures. When the discharging nozzle 12 moves relative to the cleaning device 100, the plate 110 having certain hardness is capable of break the residue exposed in the lower portion of the discharging nozzle 12. Certainly, certain hardness is sufficed for the plate 110. In other embodiments, a material of the plate 110 may also be other metallic material or hard plastic.

Moreover, the cleaning device 100 of the present embodiment includes two flexible cleaning members 120, and the notch 122 is formed between the two flexible cleaning members 120. As shown in FIG. 1A, the notch 122 includes a first trench 124 extending along a first direction D1. A cross-sectional view of the first trench 124 is in a V shape so as to correspond to the outer profile of the discharging nozzle 12. Certainly, if the outer profile of the discharging nozzle 12 is in other shapes, the cross-sectional view of the first trench 124 will be modified accordingly.

When the discharging nozzle 12 moves relative to the cleaning device 100 along the first direction D1, the discharging nozzle 12 passes through the notch 122, while the flexible cleaning members 120 move along the peripheral side of the discharging nozzle 12 to clean out the residue adhered to the peripheral side of the discharging nozzle 12. In the present embodiment, the peripheral side of the discharging nozzle 12 is scraped by the flexible cleaning members 120 having elasticity, and shapes of the flexible cleaning members 120 may slightly changed to cope with the outer profile of the discharging nozzle 12, so as to avoid colliding directly with the discharging nozzle 12 when being in contact with the discharging nozzle 12 and prevent the discharging nozzle 12 from being dislocated due to collision or being damaged.

It is worth to note that printing temperatures are approximately 230° C. to 250° C. in order to melt the filament for printing. When the discharging nozzle 12 is to be cleaned, the discharging nozzle 12 may still contain relatively high temperatures. In the present embodiment, in order to prevent the flexible cleaning members 120 from being deformed, a heat-resisting material may be selected for fabricating the flexible cleaning members 120, such as fluoro rubber (e.g., FKM) for resisting temperatures up to 300° C. or heat-resisting silicon. Whereas, in other embodiments, it will suffice as long as heat-resisting temperatures for the flexible cleaning members 120 is higher than printing temperatures. Materials for fabricating the flexible cleaning members 120 are not limited herein.

In addition, in other embodiments, the cleaning device 100 is not required to be disposed on the 3D printing apparatus 10. Rather, the cleaning device 100 moves back and forth relative to the discharging nozzle 12 through other operation means such as being manually operated by a user, so as to complete a task of cleaning the discharging nozzle 12.

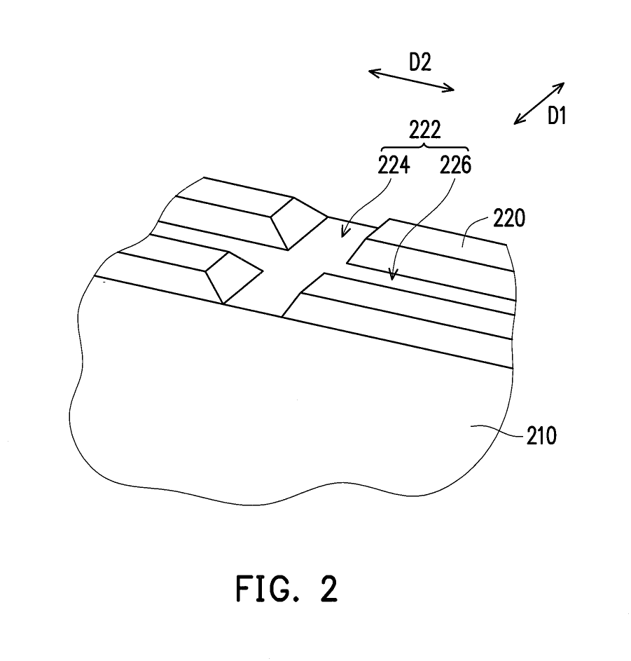

FIG. 2 is a partial 3D view illustrating a cleaning device according to another embodiment of the disclosure. With reference to FIG. 2, a main difference between the present embodiment and the previous embodiment lies in that the notch 122 of the flexible cleaning members 120 in the previous embodiment only includes the first trench 124 extending along the first direction D1. The discharging nozzle 12 of the 3D printing apparatus 10 may move on the base along the first direction D1 and a second direction D2 perpendicular to the first direction D1. In order for the flexible cleaning members 220 to clean the residue adhered to the peripheral side of the discharging nozzle 12 in a better way, a notch 222 of the present embodiment, as shown in FIG. 2, further includes a second trench 226 extending along the second direction D2. A cross-sectional view of the second trench 226 also corresponds to the outer profile of the discharging nozzle 12 and is in a nearly V shape having a wide top and a narrow bottom. According to FIG. 2, the first trench 224 and the second trench 226 intersects with each other to form a cross.

During an actual operation, after the discharging nozzle 12 moves to a location where the cleaning device 200 is positioned, the discharging nozzle 12 may, first of all, move back and forth along the first direction D1, so as to allow a plate 210 to cut off the filament at the lower portion of the discharging nozzle 12 for the flexible cleaning members 220 to remove the residue adhered to a partial area of the peripheral side of the discharging nozzle 12. Then, the discharging nozzle 12 moves back and forth along the second direction D2, so as to allow the flexible cleaning members 220 to remove the residue adhered to the other parts of the peripheral side of the discharging nozzle 12.

Furthermore, in the present embodiment, the plate 210 having a larger width and located below the flexible cleaning members 220 may be correspondingly selected, so as to carry four pieces of the flexible cleaning members 220, as shown in FIG. 2. In other embodiments, two pieces of the plates 210 may also be adopted for individually carrying a pair of the flexible cleaning members 220. A layout of the cleaning device 200 of the present embodiment is not limited herein.

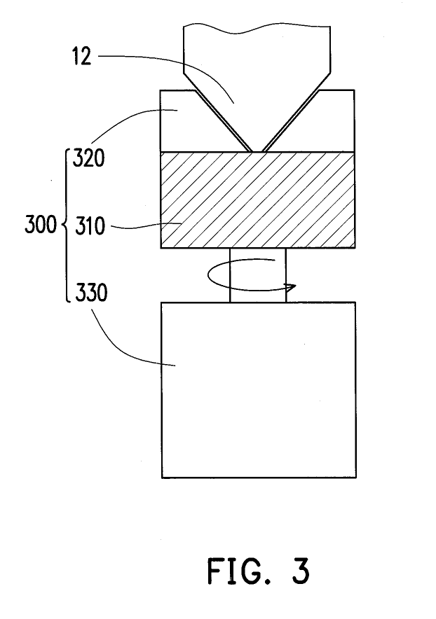

FIG. 3 is a partial 3D view illustrating a cleaning device and a discharging nozzle according to yet another embodiment of the disclosure. With reference to FIG. 3, in order to completely clean off the residue adhered to an entire peripheral side of the discharging nozzle 12, a cleaning device 300 further includes a rotating mechanism 330. A plate 310 and flexible cleaning members 320 are located on the rotating mechanism 330. In the present embodiment, the rotating mechanism 330 includes a motor. With rotations of the rotating mechanism 330, the flexible cleaning members 320 are capable of rotating at 360 degrees relative to the discharging nozzle 12 and scraping the residue adhered to the entire peripheral side of the discharging nozzle 12.

Namely, in terms of operations, the discharging nozzle 12 is moved first to a notch of the flexible cleaning members 320 of the cleaning device 300. After a remaining filament adhered to the lower portion of the discharging nozzle 12 is cut off, the discharging nozzle 12 remains still for the flexible cleaning members 320 to scrape off the residue adhered to the peripheral side of the discharging nozzle 12 in a rotatable manner by activating the rotating mechanism 330.

In light of the above, the melted filament may adhere to the discharging nozzle of the 3D printing apparatus during a 3D printing process. In addition, after the 3D printing process is completed, the filament may still adhere to the lower portion of the discharging nozzle. The cleaning device of the disclosure may be disposed on the base of the 3D printing apparatus. After the 3D printing process is completed, the discharging nozzle may be moved to a location where the cleaning device is positioned for the plate of the cleaning device to cut off the remaining filament exposed at the lower portion of the discharging nozzle, and for the flexible cleaning members to scrape off the residue adhered to side surfaces of the discharging nozzle, so as to complete a task of cleaning the discharging nozzle, such that printing quality of subsequent printing tasks will not be adversely affected. Moreover, in order to ensure complete cleanliness of the peripheral side of the discharging nozzle, the flexible cleaning members may include trenches having perpendicular directions so as to expand the scraping area of the peripheral side of the discharging nozzle. Alternatively, the plate and the flexible cleaning members may be disposed on the rotating mechanism, such that the flexible cleaning members are capable of rotating at 360 degrees and scraping off the residue adhered to the peripheral side of the discharging nozzle.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A cleaning device configured for removing a residue adhered to a discharging nozzle of a three-dimensional printing apparatus, the cleaning device comprising:
a plate; and
at least one flexible cleaning member disposed on the plate, the at least one flexible cleaning member having a notch corresponding to an outer profile of the discharging nozzle.

2. The cleaning device as claimed in claim 1, wherein the notch comprises a first trench extending along a first direction.

3. The cleaning device as claimed in claim 2, wherein a cross section of the first trench is in a V shape.

4. The cleaning device as claimed in claim 2, wherein the notch further comprises a second trench extending along a second direction, and the first direction is perpendicular to the second direction.

5. The cleaning device as claimed in claim 4, wherein a cross section of the second trench is in a V shape.

6. The cleaning device as claimed in claim 1, wherein the cleaning device is disposed on a base of the three-dimensional printing apparatus, and the base is configured to carry a sprayed object sprayed from the discharging nozzle.

7. The cleaning device as claimed in claim 1, further comprising a rotating mechanism, wherein the plate and the flexible cleaning member are located on the rotating mechanism.

8. The cleaning device as claimed in claim 7, wherein the rotating mechanism comprises a motor.

9. The cleaning device as claimed in claim 1, wherein a material of the plate comprises metal or hard plastic.

10. The cleaning device as claimed in claim 1, wherein a material of the flexible cleaning member comprises a heat-resisting material.
